(19) United States
(12) Patent Application Publication
(10) Pub. No.: US 2006/0232509 A1
(43) Pub. Date: Oct. 19, 2006

(54) Plasma display module

(76) Inventor: Kwang-Jin Jeong, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/384,421

(22) Filed: Mar. 21, 2006

(30) Foreign Application Priority Data
Apr. 13, 2005 (KR) 10-2005-0030711

(51) Int. Cl. G09G 3/28

(52) U.S. Cl. 345/60

(57) ABSTRACT

A plasma display module includes a plasma display panel displaying images using a gas discharge phenomenon, and a color temperature compensation filter in a viewing path of the plasma display panel, the color temperature compensation filter having at least one transparent region, e.g., a hole, in the viewing path.

### BACKGROUND OF THE INVENTION

1. Field of the Invention

The present invention relates to a plasma display module. More particularly, the present invention relates to a plasma display module which can perform color temperature compensation while maintaining a high luminance.

2. Description of the Related Art

A plasma display module is a flat display module that displays images using a gas discharge phenomenon. The plasma display module can be thin and provide a high-quality, large screen having a wide viewing angle. Accordingly, the plasma display module has become very popular. The plasma display module typically includes a plasma display panel having a first panel and a second panel. The plasma display panel creates images by generating a discharge in discharge cells formed therein, and exciting phosphors using ultraviolet (UV) light emitted from discharge gas to emit visible light.

Specifically, each of the discharge cells formed in the plasma display panel has a phosphor layer formed of one of red (R), green (G), and blue (B) phosphors (hereinafter, referred to as RGB phosphors). The RGB phosphor layers may be formed by sequentially coating the RGB phosphors in three discharge cells that are consecutively adjacent to each other. The three consecutive discharge cells, which are coated with RGB phosphors, respectively, constitute one unit pixel.

In a conventional plasma display module, visible light generated from a blue phosphor, i.e., blue light, has a relatively low luminance ratio compared with other visible light. Therefore, in order to output visible light having a suitable color temperature favored by most consumers, a color temperature compensating filter has been used in conventional plasma display modules.

However, the color temperature compensating filter partially absorbs or reflects visible light emitted from the plasma display panel, significantly reducing the luminance of the entire plasma display module.

### SUMMARY OF THE INVENTION

The present invention is therefore directed to a plasma display module, which substantially overcomes one or more of the problems due to the limitations and disadvantages of the related art.

It is therefore a feature of an embodiment of the present invention to provide a plasma display module including a color temperature compensating filter attached to a surface of a plasma display panel from which visible light is emitted, wherein the color temperature compensating filter has at least one hole.

It is therefore another feature of an embodiment of the present invention to provide a plasma display module including a color temperature compensating filter that allows the plasma display module to produce images having high luminance as well as to perform color temperature compensation.

At least one of the above and other features and advantages of the present invention may be realized by providing a plasma display module, including a plasma display panel and a color temperature compensation filter in a viewing path of the plasma display panel, the color temperature compensation filter having at least one transparent region in the viewing path.

The color temperature compensation filter compensates a color temperature of the peak of the visible light generated by the plasma display panel. The color temperature compensation filter may be a blue type compensation filter. The transparent region of the color temperature compensation filter may be circular.

The color temperature compensation filter may have at least two layers made of first and second filter units. The first filter unit may be a color temperature compensation layer and the second filter unit may be a bonding layer.

The color temperature compensation filter may cover an entire surface of the plasma display panel from which the visible light is emitted. The color temperature compensation filter may be an acetate-based material.

An area of the transparent region in the color temperature compensation filter may maintain a luminance of the plasma display panel and a color compensation of the color temperature compensation filter.

The transparent region may be a hole. The transparent region may be a plurality of holes. The plurality of holes may be arranged in a regular pattern.

At least one of the above and other features and advantages of the present invention may be realized by providing a method of correcting a color temperature of a plasma display module, including displaying an image using a gas discharge phenomena, and providing a color temperature compensation filter in a viewing path of the plasma display module, the color temperature compensation filter having at least one transparent region in the viewing path.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a partially exploded perspective view of a plasma display module according to an exemplary embodiment of the present invention;

FIG. 2 illustrates a partially cutaway view taken along line II-II of FIG. 1; and

FIG. 3 illustrates a partially enlarged perspective view of a color temperature compensating filter of FIG. 1.

### DETAILED DESCRIPTION OF THE INVENTION

Korean Patent Application No. 10-2005-0030711, filed on Apr. 13, 2005, in the Korean Intellectual Property Office, and entitled: “Plasma Display Module,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. It will also be understood that when a layer is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

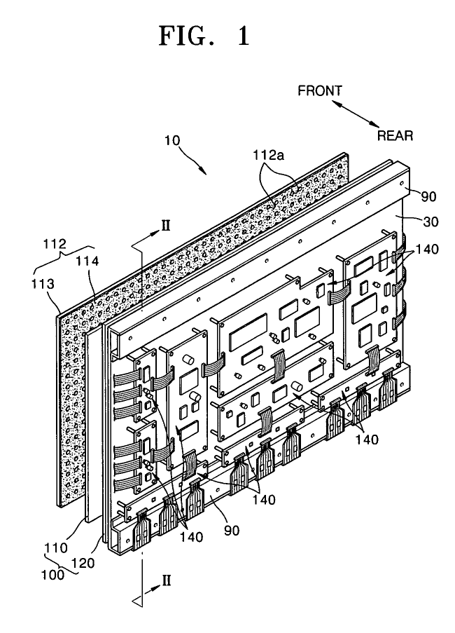

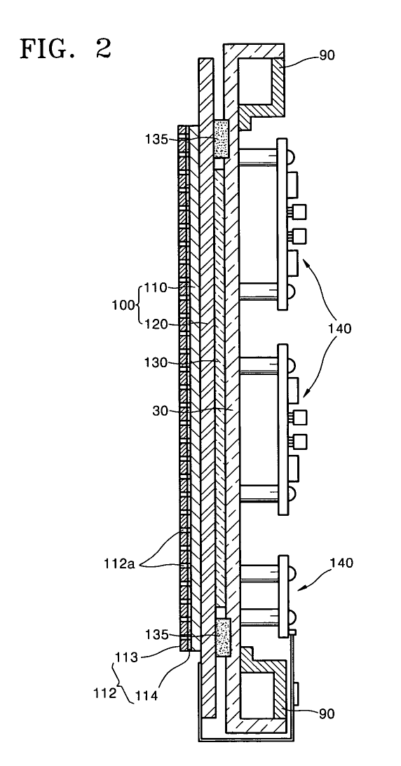

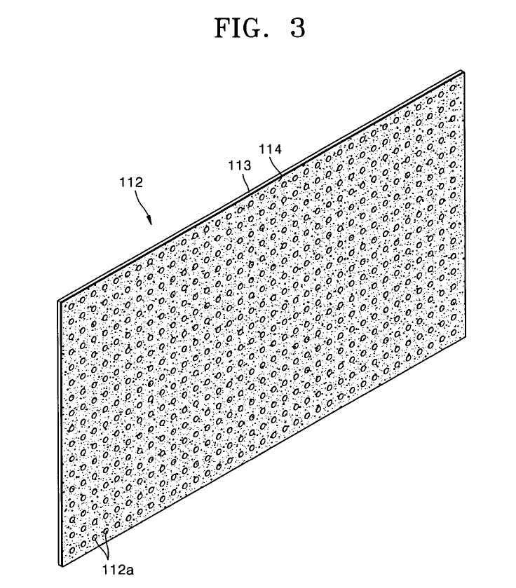

FIG. 1 illustrates a partially exploded perspective view of a plasma display module 10 according to an embodiment of the present invention. FIG. 2 is a partially cutaway view taken along line II-II of FIG. 1. FIG. 3 illustrates a partially enlarged perspective view of a color temperature compensation filter 112 of FIG. 1. Referring to FIGS. 1, 2 and 3, the plasma display module 10 includes a plasma display panel 100 on which images are displayed.

The plasma display panel 100 may be one of various types of plasma display panels. In the present embodiment, the plasma display panel 100 is a three-electrode surface discharge type AC plasma display panel. In this case, the plasma display panel 100 includes first and second panels 110 and 120. Although not shown in the drawings, the first panel 110 may include a first substrate, a plurality of sustain electrode pairs formed on the first substrate, a first dielectric layer in which the sustain electrode pairs are buried and a protection layer coated on the surface of the first dielectric layer. Each of the sustain electrode pairs may include a common electrode and a scan electrode in strips.

The second panel 120 is opposite to the first panel 110. Although not shown in the drawings, the second panel 120 may include a second substrate, a plurality of address electrodes formed on the second substrate and crossing the sustain electrode pairs, a second dielectric layer in which the address electrodes are buried, barrier ribs formed on the second dielectric layer to define discharge cells and prevent crosstalk, and RGB phosphor layers coated in the discharge cells defined by the barrier ribs.

The discharge cells correspond to intersections between the sustain electrode pairs and the address electrodes. The discharge cells are filled with discharge gases.

An operation of the plasma display panel 100 having the aforementioned structure will now be described. First, when the plasma display panel 100 receives a voltage from an external power source, address discharge is caused by the address electrodes and the scan electrodes, and then sustain discharge is caused by the scan electrodes and the common electrodes.

When the energy level of the discharge gas excited during the sustain discharge decreases, ultraviolet (UV) light is emitted by the discharge gas. The emitted UV light excites the phosphors of the phosphor layers formed in the discharge cells so they emit visible light. The visible light is transmitted through the plasma display panel 100, forming an image that can be perceived by users, so that the image is displayed on the plasma display panel 100.

Generally, a luminance ratio of visible light emitted from the RGB phosphors is approximately 28:62:10 (R:G:B). A color temperature of the peak of a visible light generated in a unit pixel is about 8,000 K. Typically, as the interval between the RGB luminance values in the luminance ratio increases, the color temperature decreases.

The color temperature indicates how hot or cold a color is, and typically varies between 6,500 K and 9,300 K. The color temperature of a black body radiator is equal to its surface temperature in kelvins K, where K represents an absolute temperature. Higher values of K indicate brighter and colder colors, i.e., closer to blue. Lower values of K indicate warmer colors, i.e., closer to red. Everyone has a different preference for the color temperature, but most people prefer a high color temperature which is close to blue.

In addition, a chassis 30 may be provided on a surface of the plasma display panel 100 to support and prevent the plasma display panel 100 from being damaged by an external impact. The chassis 30 may be bonded to a surface of the plasma display panel 100 using an adhesive member 135, e.g., a double-sided tape.

The plasma display module 10 may include a heat-sink pad 130 disposed between the chassis 30 and the plasma display panel 100 to avoid thermal accumulation caused by the heat generated when the plasma display panel 100 is driven. The heat-sink pad 130 may be made of, e.g., aluminium, copper or a thermally conductive resin.

A drive circuit unit 140 for generating electrical signals to drive the plasma display panel 100 may be installed on a surface of the chassis 30 opposite to the surface to which the plasma display panel 100 is bonded. The drive circuit unit 140 may have various electrical components to supply electrical power and apply voltage signals used to display images.

The plasma display module 10 according to the present embodiment may include a color temperature compensation filter 112 arranged on a surface of the plasma display panel 100 through which visible light is emitted, to compensate a color temperature of the peak of visible light emitted by the plasma display panel 100.

The color temperature compensation filter 112 corrects a color temperature of the peak of the visible light emitted from the plasma display panel 100 in order to provide a color preferred by most people. By reducing the luminance of R and G light, it is possible to reduce differences between luminances of B light and R light, and between luminances of B light and G light. As a result, the color temperature of the visible light emitted from the plasma display panel 100 can be increased, so that the output color can be closer to blue.

In other words, the color temperature compensation filter 112 reduces the luminance of one or two of the R, G, and B lights, and may be a yellow type, a magenta type, a green type, a red type, a blue type, etc. In addition, there are at least forty kinds of filters, each having a different color temperature compensating effect. Thus, compensation of most colors is possible.

The color temperature compensation filter 112 may be made of an acetate-based material. However, any suitable material known to those skilled in the art may be used. The color temperature compensation filter 112 may have a thickness equal to or approximately equal to a thickness of any suitable filter known in the art. The color temperature compensation filter 112 may be a blue type.

The color temperature compensation filter 112 may have at least one transparent region, e.g., a hole 112a. As a result, it is possible to increase a transmittance of a blue light and to reduce transmittances of red and green lights, so that the luminance differences of the RGB colors can be reduced and the color temperature of the entire output visible lights can be increased. Accordingly, the transmittance of the plasma display panel 100 can be prevented from decreasing due to the partial absorption or reflection of the visible lights by the color temperature compensation filter 112 installed on the surface of the plasma display panel 100. Consequently, a reduction of the entire luminance of the plasma display module 10 can be prevented.

In other words, when visible light is emitted from the plasma display panel 100, it is partially absorbed or reflected by the color temperature compensation filter 112, so that the amount of visible light transmitted through the color temperature compensation filter 112 may be reduced. To overcome this drawback, in the plasma display module 10 according to the present embodiment, a plurality of holes 112a may be formed on the color temperature compensation filter 112. As a result, the amount of the visible light transmitted through the plasma display panel 100 and directly emitted through the holes 112a without passing though the color temperature compensation filter 112 can be increased. The color temperature compensation effect using a conventional color temperature compensation filter without holes may still be maintained with the color temperature compensation filter according to the present invention.

In addition, the holes 112a formed in the color temperature compensation filter 112 may have various sizes. If the size of the hole is too large, the transmittance of the visible light may increase so that the output luminance can be improved, but the color temperature compensation effect may be degraded. If the size of the hole is too small, the color temperature compensation effect may be improved, but the transmittance may be reduced. Accordingly, the size of the holes 112a is preferably as large as possible while maintaining the color temperature compensation effect of the color temperature compensation filter 112. Similarly, a total area of the color temperature compensation filter occupied by the plurality of holes 112a is preferably as large as possible while maintaining the color temperature compensation effect of the color temperature compensation filter 112.

Furthermore, the holes 112a formed in the color temperature compensation filter 112 may have a circular shape. However, the shape of the holes 112a is not limited thereto, and may be triangular, rectangular, elliptical or pentagonal. Further, while the pattern of holes 112a in the color temperature compensation filter 112 is shown as being regular in FIGS. 1-3, they may be arranged in any pattern, as long as an area of the holes 112a in the color compensation filter 112 is sufficient to maintain luminance and the color compensation. Additionally, while a regular pattern may provide uniform luminance/color correction over the viewing area, the pattern may be used to vary the luminance across the viewing area, e.g., to compensate for any imbalance in luminance in the plasma display panel itself. Finally, while the color compensation filter 112 is depicted as having holes therethrough, these holes may also correspond to a transparent region which does not color compensate the visible light. Thus, the trade-off for a particular desired luminance or color temperature may be realized by adjusting the transparent regions.

The color temperature compensation filter 112 may include first and second filter units 113 and 114. The first filter unit 113 may be a color temperature compensation layer and the second filter unit 114 may be a bonding layer. By using the second filter unit 114, the color temperature compensation filter 112 can be bonded to the surface of the plasma display panel 100.

The color temperature compensation filter 112 may fully cover the surface of the plasma display panel 100. However, the present invention is not limited thereto, and the color temperature compensation filter 112 may be smaller, as long as the same effect as that produced by the full-cover size filter 112 can be achieved. Also, various numbers of color temperature compensation filters 112 may be installed on the plasma display panel 100.

The color temperature compensation filter 112 may be made of an acetate-based material. However, the present invention is not limited thereto, and the color temperature compensation filter 112 may be made of other materials as long as the same effect can be achieved.

According to the present invention, a plasma display module includes a color temperature compensation filter attached to a surface of a plasma display panel from which visible light is emitted. In addition, the color temperature compensation filter includes at least one hole. As a result, the plasma display module of the present invention can perform color temperature compensation while maintaining a high luminance. In addition, the plasma display module according to the present invention may provide a high color temperature and a high luminance preferred by most consumers.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display module, comprising:
a plasma display panel; and
a color temperature compensation filter in a viewing path of the plasma display panel, the color temperature compensation filter having at least one transparent region in the viewing path.

2. The plasma display module as claimed in claim 1, wherein the color temperature compensation filter compensates a color temperature of the peak of the visible light generated by the plasma display panel.

3. The plasma display module as claimed in claim 1, wherein the color temperature compensation filter is a blue type compensation filter.

4. The plasma display module as claimed in claim 1, wherein the transparent region of the color temperature compensation filter is circular.

5. The plasma display module as claimed in claim 1, wherein the color temperature compensation filter has at least two layers made of first and second filter units.

6. The plasma display module as claimed in claim 5, wherein the first filter unit is a color temperature compensation layer and the second filter unit is a bonding layer.

7. The plasma display module as claimed in claim 1, wherein the color temperature compensation filter covers an entire surface of the plasma display panel from which the visible light is emitted.

8. The plasma display module as claimed in claim 1, wherein the color temperature compensation filter is an acetate-based material.

9. The plasma display module as claimed in claim 1, wherein an area of the transparent region in the color temperature compensation filter maintains a luminance of the plasma display panel and a color compensation of the color temperature compensation filter.

10. The plasma display module as claimed in claim 1, wherein the transparent region is a hole.

11. The plasma display module as claimed in claim 10, wherein the transparent region is a plurality of holes.

12. The plasma display module as claimed in claim 11, wherein the plurality of holes is arranged in a regular pattern.

13. A method of correcting a color temperature of a plasma display module, comprising;
displaying an image using a gas discharge phenomena; and
providing a color temperature compensation filter in a viewing path of the plasma display module, the color temperature compensation filter having at least one transparent region in the viewing path.

14. The method as claimed in claim 13, wherein the transparent region of the color temperature compensation filter is circular.

15. The method as claimed in claim 13, wherein the color temperature compensation filter covers an entire surface of the plasma display panel from which the visible light is emitted.

16. The method as claimed in claim 13, wherein an area of the transparent region in the color temperature compensation filter maintains a luminance of the plasma display panel and a color compensation of the color temperature compensation filter.

17. The method as claimed in claim 13, wherein the transparent region is a hole.

18. The method as claimed in claim 17, wherein the hole is a plurality of holes.

19. The plasma display module as claimed in claim 18, wherein the plurality of holes is arranged in a regular pattern.
